(19) United States
(12) Patent Application Publication
(10) Pub. No.: US 2005/0210507 A1
(43) Pub. Date: Sep. 22, 2005

(54) System and method for multimedia playlist

(75) Inventors: Ronald Bruce Hawkins, San Diego, CA (US); Richard Berger, Milburn, NJ (US); Keith Kocho, Scarborough, CA (US)

Correspondence Address: ROGITZ & ASSOCIATES, 750 B Street, Suite 3120, San Diego, CA, 92101, US

(73) Assignees: SONY CORPORATION, Tokyo (JP); SONY CORPORATION of AMERICA, New York, NY (US); EXTENDMEDIA, INCORPORATION, Toronto (CA)

(21) Appl. No.: 10/802,589

(22) Filed: Mar. 17, 2004

(51) Int. Cl. H04N 7/025; G06F 3/00; H04N 7/10; G06F 17/30; G06F 7/00; H04N 5/445

(52) U.S. Cl. 725/46; 725/34; 725/35; 725/45

(57) ABSTRACT

A playlist of multimedia content is generated based on the results of a search algorithm operating on a metadata database connected to a network. The search algorithm utilizes a search vector that is generated using demographic data and consumer profile data, and/or based on a consumer search request. The playlist, which can list heterogeneous titles of multimedia content, may be accessed anywhere on the network by any suitable authorized device.

### I. FIELD OF THE INVENTION

The present invention relates generally to multimedia playlists.

### II. BACKGROUND

Due to the rapid proliferation of digital entertainment options, consumers are increasingly faced with a greater diversity and complexity of types and modes of receiving digital entertainment. For example, in the case of digital content types, there are Internet-based digital music and video download services, digital video recorders, digital video-on-demand from cable television providers, digital online and packaged-software games, consumer-generated personal digital photos and movies, etc. Consumers may now receive, store, and play back digital entertainment content on a variety of consumer electronics devices, including personal computers, handheld computers (“personal digital assistants”), personal video recorders, portable digital music players, game consoles, digital still and moving image cameras, etc. The present invention understands that the increasing complexity and variety of digital entertainment options makes challenging the process of locating, receiving, storing, and playing back digital content according to a consumer's individual tastes.

To date, multimedia playlists directed to the above problems have insufficiently solved them, because the playlists have suffered from the deficiencies of being limited to one kind of media or one specific device or type of device. For the reasons set forth above, this is inadequate to address the increasing diversity of multimedia types and display devices. Further, current playlists are difficult to share among multiple consumers, yet file sharing is desirable for many people. With these considerations in mind, the invention below is provided.

### SUMMARY OF THE INVENTION

A system for generating a playlist of multimedia titles includes at least one database and at least one digital processor accessing the database and configured for communicating with a client device over a network. The processor executes logic that includes accessing at least one database containing descriptive data representing heterogenous multimedia content. The logic also includes generating at least one search vector by accessing at least one database containing data selected from the group consisting of third party marketing data, demographic data, consumer profile data, and consumer search history data. In addition or as an alternative the search vector can be generated based on receiving a search command from a consumer. The logic uses the search vector to generate a playlist and associates the playlist with the consumer, such that the consumer can access the playlist over the network.

In non-limiting embodiments the playlist is not specific to a particular client device. If desired, the playlist is stored on the network such that the consumer can share the playlist with other users on the network. The logic may include allowing a user to select a title from the playlist and if metadata associated with the title indicates a billable event, billing the user for downloading content associated with the title. The billing of the consumer is recorded in a database communicating with the network.

In another aspect, a method for generating a multimedia playlist for display thereof to a consumer operating a client device communicating with a network includes accessing profile data associated with the consumer and accessing historical search and purchasing data. The method also includes retrieving historical search and purchasing data based on the profile data associated with the user. Using retrieved historical search and purchasing data, multimedia content that is not constrained to be homogenous is searched for, and a playlist generated based on the search results.

In still another aspect, a network for providing a consumer with titles of heterogenous multimedia content expected to be of interest to the consumer includes means for storing profile data related to the consumer, and at least one of: demographic data and historical search data associated with the consumer. Means are provided for generating a playlist associated with the consumer based on the data. The playlist includes titles of heterogenous multimedia content expected to be of interest to the consumer. The network also includes means for allowing the consumer to access the network to display the playlist and select at least one entry thereon.

In still another aspect, the network also includes means for allowing the consumer to transfer, via a communications protocol, the playlist to other consumers as a means of sharing mutual interests in digital entertainment content.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system;

FIG. 2 is a flow chart of the initialization logic;

FIG. 3 is a flow chart of the logic for constructing a playlist without consumer-entered search criteria;

FIG. 4 is a flow chart of the logic for constructing a playlist with consumer-entered search criteria; and

FIG. 5 is a flow chart of the logic for presenting the playlist to the consumer.

### DETAILED DESCRIPTION OF THE PREFERRED EMBODIMENT

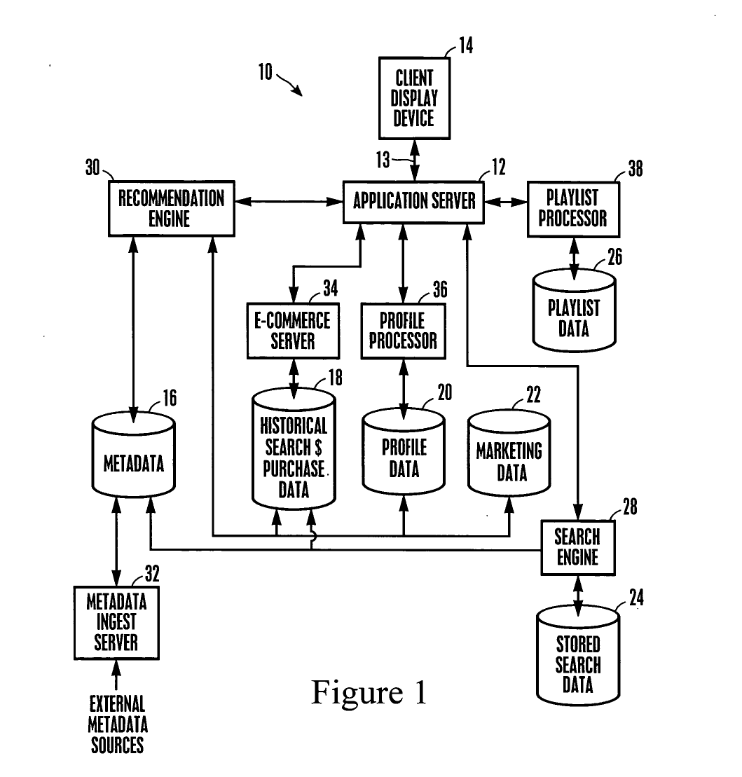

Referring initially to FIG. 1, a system is shown, generally designated 10, which includes an application server 12 that communicates playlists over a network 13 to a client device 14 and that receives input from the client device 14 over the network. The client device 14 may be, e.g., a personal computer or other consumer electronics device, such as a digital video recorder, a set-top box, a handheld computer, or a mobile telephone. The below-described multimedia playlists are not specific, however, to the type of client device 14. Rather, a playlist is associated with a consumer, and the playlist may be accessed by the consumer using any one of a number of client devices.

As shown, the application server 12 also communicates with several other servers or processors (i.e., digital processing apparatus) for executing the logic herein. Also, the other servers/processors access plural databases as set forth further below. It is to be understood that more or fewer digital processing apparatus and databases may implement the functionality of those disclosed below.

In the non-limiting exemplary system 10 shown in FIG. 1, the databases of the present invention include a metadata database 16, which stores descriptive and ancillary data about multimedia entertainment that is available from various sources, including from broadcast and cable television channels, DVDs, CDs, PVRs, and the like. The multimedia data is heterogenous, e.g., it can include video programs, music streams, TV programs, etc. The metadata entry for a title can represent the storage location of a multimedia file, channel number and air time if the title is a broadcast TV program, genre, synopsis, length of play, price (if applicable), usage restriction, rights information, and other data.

Also, a historical search database 18 can store results data from previous metadata searches and the results of e-commerce purchases of multimedia entertainment content by consumers, as set forth further below. Furthermore, the system 10 can include a profile database 20 which stores information about consumers and their preferences for multimedia content. Furthermore, a third party marketing database 22 can store aggregated demographic and preference information about consumers that is gathered or purchased from third party data providers such as direct marketing firms or other sources. Still further, a stored search database 24 stores search vectors that have been created by consumers. And, a playlist database 26 can store the multimedia playlists that are created as set forth below. The playlists may be rendered in extensible markup language (XML) format or other format, e.g., hypertext markup language (HTML), spreadsheet format, database format, etc. A playlist might be hierarchical, i.e., it might contain an entry that points to another playlist. In any case, a playlist is a list of multimedia titles that are or that will become available to a consumer viewing the playlist.

As mentioned above, in some implementations each of the six databases may be physically separate from each other and/or distributed databases, or they may be “virtual” partitions of a single database management system.

As shown in FIG. 1, the system 10 includes several servers (or equivalently several programs implemented by fewer processors) that execute the logic below. More specifically, the application server 12 contains the overall control or business logic for the system, consumer interface generation, communications with the client device 14 over a communication network, and communications/control of other playlist generation system processes. In addition to the application server 12, a search engine 28 that accesses the metadata, historical search, and stored search databases 16, 18, 24 communicates with the application server 12 to execute searches of the metadata database 16 according to preprogrammed algorithms and search criteria (FIG. 3) or constraints that are selected or entered by the consumer (FIG. 4). Moreover, a recommendation engine 30 that accesses the historical search, profile, and marketing databases 18-22 and the metadata database 16 communicates with the application server 12 to generate automatic searches of the metadata database 16. As set forth further below, these searches are executed according to pre-programmed algorithms and search criteria based on consumer preference data in the profile database 20, historical search data that is stored in the historical search database 18, and third party marketing data that is stored in the marketing database 22.

FIG. 1 further shows that a metadata ingest server 32 communicates with the metadata database 16 and with external metadata sources to import multimedia entertainment content metadata from a variety of sources and correctly store it in the metadata database 16 according to data structures that are defined in accordance with metadata principles known in the art. Also, an e-commerce server 34 that communicates with the historical database 18 and the application server 12 can manage the purchase of multimedia entertainment selected by the consumer as set forth further below.

Additionally, if desired a profile processor 36 can communicate with the application server 12 and with the profile database 20 for purposes to be shortly disclosed. Also, a playlist processor 38 can communicate with the application server 12 and playlist database 26 for purposes discussed below.

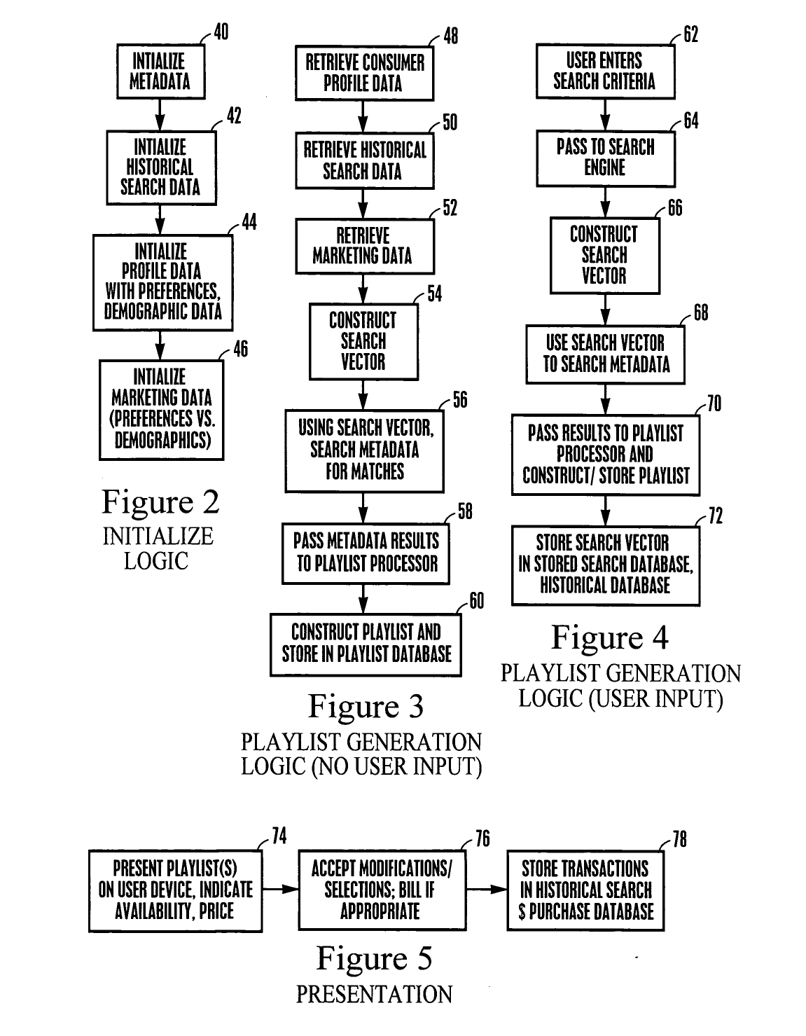

Now referring to FIG. 2, the initialization process can be seen. Commencing at block 40, the metadata database 16 is initialized by invoking the metadata ingest server 32 to import multimedia entertainment metadata from a variety of external sources, including, e.g., the Internet, cable or broadcast head ends, DVDs, PVRs, etc. that are accessible to the system 10. The metadata from external sources may be stored in a variety of file or database formats. The metadata ingest server 32 reads each file or database format, checks the data for errors according to predetermined criteria, and stores the imported metadata into the data structures that have been defined in the metadata database 16. Following initialization of the metadata database 16, the ingest process periodically may be repeated, to update the metadata database 16.

Moving to block 42, the historical database 18 is initialized. In the case of the initial operation of the system 10, the database 18 is initialized to a “null” state, and as explained below, data subsequently is accumulated in the historical search database 18 as searches are completed. Then, at block 44 the system initializes the profile database 20. A unique profile is created for each consumer that uses the system 10. The profile data can be collected from the consumers during a registration process, and the profile information can include basic data about the consumer (gender, age, income range, marital status, etc.) and data about the consumer's preferences for multimedia entertainment, such as music and movie genres, artists, specific titles, etc. The registration may be conducted using an online consumer interface or over the telephone with a customer service representative. The data is supplied to the profile processor 36, which creates the appropriate profile records and stores them in the profile database 20. The consumer profile data may be managed according to established privacy policy that is compliant with state and federal laws regarding consumer privacy.

Next, at block 46 the third party marketing data database 22 is initialized. The database 22 contains aggregated information about consumer preferences for multimedia entertainment according to various demographic characteristics. This data may be obtained or purchased from various third party providers that specialize in the collection of such data, as well as from other marketing databases that may be available. This database may be updated periodically using updates supplied by or purchased from the third party provider.

Following initialization of the databases, automated playlist generation can occur by either or both of two methods, shown in FIGS. 3 and 4. These methods may be executed in any order, including concurrently or randomly.

Commencing at block 48 in FIG. 3, the recommendation engine 30 retrieves consumer profile data for the particular consumer from the profile database 20. At block 50, historical search data correlated to the consumer is retrieved from the historical search database 18, and at block 52 third party marketing data is obtained from the third party marketing data database 22.

Proceeding to block 54, the data obtained in blocks 48-52 is used to generate a search vector in accordance with search principles known in the art. For example, based on the consumer's profile and using the demographic preference information in the marketing database, a search vector can be constructed to retrieve titles indicated as being relevant to the particular consumer, given his or her profile, as indicated by the marketing database. Also, a search vector can be constructed along the lines of previous search vectors associated with the consumer. For example, if the consumer previously searched for the title “Zulu”, a search vector useful for retrieving information about Africa, or the Boer War, or Michael Caine, might be created. Methods for constructing search vectors are known in the art.

Moving to block 56, the recommendation engine 30 searches the metadata database 16 for matches. Results that match the constraints of the search vector are retrieved and, at block 58, passed to the playlist processor 38. At block 60 the playlist processor 38 constructs a data structure that comprises the multimedia playlist and copies the appropriate elements of the metadata record set into the playlist. The playlist processor 38 stores the resultant multimedia playlist in the playlist database 26. It is to be understood that the resultant multimedia playlist is uniquely associated with the specific consumer whose profile was used to generate the playlist.

FIG. 4 shows the second method of automated playlist generation. Commencing at block 62, the consumer, through the client device 14, enters various search criteria. At block 64 the application server 12 sends the search criteria to the search engine 28, which constructs a search vector based thereon at block 66. At block 68 the search vector is used by a search algorithm in the search engine 28 to retrieve from the metadata database 16 the metadata records matching the search criteria. Moving to block 70, the results of the search are passed to the playlist processor 28 for construction and storage of a playlist as set forth above. At block 72 the search engine 28 stores the search vector in the stored search database 24 and in the historical search database 18 and uniquely associates it with the specific consumer that created it. Once playlists have been stored, the recommendation engine can use this data to construct future recommendations of the type: “Consumers who searched for X also search for Y, Z, etc.” The stored search can be recalled by the search engine 28 and run periodically to “refresh” the search results based on new or changing content metadata. The periodicity of refreshing stored searches can be established by operational personnel using an administrative interface or optionally by the consumer using a consumer interface delivered by the application server 12.

Once playlists have been created and stored in the playlist database 26, the logic of FIG. 5 may be invoked by the application server 12 to recall a playlist for a particular consumer or consumer (based on the consumer ID) and to present the playlist on the client device 14 at block 74. At block 76 consumer-generated modifications to the playlist and selections from the playlist can be received and passed to the playlist processor 38 for processing and storage. For selections requiring payment, billing can be undertaken by the e-commerce server 34, which records the transaction in the historical database 18.

Accordingly, once created, playlists are stored in the playlist database 26 which resides on a computer server that is connected to the communications network 13. Thus, each consumer may access his/her respective playlists from any client device that is connected to the communications network 13 and that is authorized to connect to the playlist processor 38. Multiple playlist servers may be provided if desired in different physical locations. Those skilled in the art will recognize the advantage in creating such a distributed server architecture, which improves performance and reliability of the system 10.

In addition to server based storage, playlists may also be downloaded and stored on a client device, assuming the device has the requisite storage capability. This feature of the invention permits a consumer to view his/her playlists during periods when a client device may not be connected to the communications network. In some implementations, facilities are provided for ensuring that playlists are properly synchronized when transferring from online to offline operation and vice-versa. The synchronization process ensures that the data contained in each copy of a playlist are identical.

Another inventive aspect of the multimedia playlists generated herein is the ability to reference content that is not immediately available and to signify whether all content in the playlist is available for playback (playlist is “ready”) or whether availability is pending (playlist is “incomplete”). Each content metadata record preferably contains information about the location of the content. In the case of digital content files that are available for download, the location information might be an Internet address of a server where the content is stored. In the case of a future television program that is to be digitally recorded (e.g., using a digital video recorder), the “location” would be a channel number and air time. In the case of content that has not yet been downloaded or recorded and stored on one of the consumer's playback devices, the content is said to be “pending” and the playlist is said to be “incomplete.” Once the content has been retrieved or recorded and stored on one of the consumer's playback devices (e.g., a personal computer or set-top box), then the content is said to be “available” and the playlist is said to be “ready.” The multimedia playlists described herein also support the notion of a predicted availability time. For example, if the only pending content item in a playlist is a future television program with a specified air time, then the predicted availability of the playlist will be the air time of the pending program plus the length of the program itself (i.e., the ending time of the program).

Some content items referenced by the present multimedia playlists may require the consumer to purchase the right to use the content. This content can be considered to be “premium” content. The metadata records contained in the playlist can signify whether or not the content is premium and if so, will include ancillary information such as purchase price. The consumer interface and logic necessary to support the purchase activity can be supplied to the consumer's client device 14 by the application server 12. The actual purchase transaction, as mentioned above, can be managed by the e-commerce server 34, which can be implemented according to standard practices for e-commerce systems. Following the completion of an e-commerce transaction, the e-commerce server 34 stores information about the transaction in the historical search database 18, where it is used by the recommendation and search engines 30, 28 to construct future recommendations of the type “Consumers who bought this title (X) also bought these titles (Y, Z etc.)” The metadata can also contain information regarding “digital rights management” that specifies rights to copy, distribute, and otherwise manage content that is purchased. The DRM information in the metadata may also include references to servers (processors, network addresses) where licenses can be obtained to decrypt and use premium content after purchase.

Because the playlists are available on a communication network 13, consumers may share playlists with each other to develop “communities” amongst consumers who share similar social circles or interests in multimedia content. Moreover, “super-distribution” of content, in which the sharing of a playlist between one consumer and another prompts the second consumer to acquire or purchase new content items, is facilitated—a potentially powerful marketing tool for expanding the distribution of commercial multimedia content. A variety of communication protocols may be used to transfer playlists among consumers, including electronic mail, file transfer protocol (ftp), hypertext transfer protocol (http), instant messaging protocols, text messaging protocols, and others.

While the particular SYSTEM AND METHOD FOR MULTIMEDIA PLAYLIST as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

1. A system for generating a playlist of multimedia titles, comprising:
at least one database;
at least one digital processor accessing the database and configured for communicating with a client device over a network, the processor executing logic including:
accessing at least one database containing data representing heterogenous multimedia content;
generating at least one search vector by undertaking at least one of:
accessing at least one database containing data selected from the group consisting of third party marketing data, demographic data, consumer profile data, and consumer search history data; and
receiving a search command from a consumer; and
using the search vector, generating a playlist and associating the playlist with the consumer, such that the consumer can access the playlist over the network.

2. The system of claim 1, wherein the playlist is not specific to a particular client device.

3. The system of claim 1, wherein the logic comprises generating the search vector by accessing at least one database containing data selected from the group consisting of third party marketing data, demographic data, consumer profile data, and consumer search history data.

4. The system of claim 1, wherein the playlist is stored on the network, such that the consumer can share the playlist with other users on the network.

5. The system of claim 1, wherein the logic comprises allowing a user to select a title from the playlist and if metadata associated with the title indicates a billable event, billing the user for downloading content associated with the title.

6. The system of claim 5, wherein the logic comprises recording billing of the consumer in a database communicating with the network.

7. The system of claim 1, wherein the logic comprises generating the search vector based on a search command received from the consumer, the search vector being stored in at least one database on the network.

8. A method for generating a multimedia playlist for display thereof to a consumer operating a client device communicating with a network, comprising:
accessing profile data associated with the consumer;
accessing historical search and purchasing data;
retrieving historical search and purchasing data based on the profile data associated with the user;
using retrieved historical search and purchasing data, searching for multimedia content, the multimedia content not being constrained to be homogenous; and
generating a playlist based on the searching act.

9. The method of claim 8, comprising presenting the playlist to the consumer using a client device communicating with the network without constraining the client device to be a particular single type of device.

10. The method of claim 8, further comprising generating a playlist using a consumer search command.

11. The method of claim 10, wherein the playlist is stored in a database on the network.

12. The method of claim 8, wherein the playlist is stored on the network, such that the consumer can share the playlist with other users on the network.

13. The method of claim 8, comprising allowing a user to select a title from the playlist and if metadata associated with the title indicates a billable event, billing the user for downloading content associated with the title.

14. The method of claim 13, comprising recording billing of the consumer in a database communicating with the network.

15. The method of claim 8, comprising generating a search vector based on a search command received from the consumer, the search vector being stored in at least one database on the network.

16. A network for providing a consumer with titles of heterogenous multimedia content expected to be of interest to the consumer, comprising:
means for storing profile data related to the consumer, and at least one of: demographic data, and search data associated with the consumer;
means for generating a playlist associated with the consumer based on the data, the playlist including titles of heterogenous multimedia content expected to be of interest to the consumer; and
means for allowing the consumer to access the network to display the playlist and select at least one entry thereon.

17. The network of claim 16, comprising:
means for accessing profile data associated with the consumer;
means for accessing historical search and purchasing data;
means for retrieving historical search and purchasing data based on the profile data associated with the user;
means for, using retrieved historical search and purchasing data, searching for multimedia content, the multimedia content not being constrained to be homogenous; and
the means for generating a playlist accessing results of the means for searching.

18. The network of claim 16, further comprising means for generating a playlist using a consumer search command.

19. The network of claim 18, wherein the playlist is stored in a database on the network.

20. The network of claim 16, wherein the playlist is stored on the network, such that the consumer can share the playlist with other users on the network.

21. The network of claim 16, comprising means for allowing a user to select a title from the playlist, and
means for billing the user for downloading content associated with the title if metadata associated with the title indicates a billable event.

22. The network of claim 16, comprising means for generating a search vector based on a search command received from the consumer, the search vector being stored in at least one database on the network.
